(19) United States
(12) Patent Application Publication
(10) Pub. No.: US 2015/0077437 A1
(43) Pub. Date: Mar. 19, 2015

(54) Method for Implementing Electronic Magnifier and User Equipment

(71) Applicant: Huawei Technologies Co., Ltd., Shenzhen (CN)

(72) Inventors: Yishi Yin, Shenzhen (CN); Janakiraman Thiyagarajah, Solitaire (IN)

(21) Appl. No.: 14/551,303

(22) Filed: Nov. 24, 2014

Related U.S. Application Data
(63) Continuation of application No. PCT/CN2014/071023, filed on Jan. 21, 2014.

(30) Foreign Application Priority Data
Aug. 30, 2013 (CN) 201310390683.1

(51) Int. Cl. G06T 3/40; G06F 3/03

(52) U.S. Cl. CPC G06T 3/40; G06F 3/03
USPC 345/671

(57) ABSTRACT

A method for implementing an electronic magnifier and a user equipment (UE), which relate to the field of electronic devices, and can facilitate a user operation and content viewing. The method in the present invention mainly includes after an electronic magnifier of a UE is activated, determining information about a tilt angle variation of the UE's display screen using a gravity sensor of the UE; and moving a magnified area of the electronic magnifier according to the information about the tilt angle variation, where the magnified area of the electronic magnifier is a part of a display area of the display screen, so that displayed content entering the magnified area is magnified and displayed. Embodiments of the present invention are mainly applied in a process of implementing a magnifier in an electronic device.

### CROSS-REFERENCE TO RELATED APPLICATIONS

This application is a continuation of International Application No. PCT/CN2014/071023, filed on Jan. 21, 2014, which claims priority to Chinese Patent Application No. 201310390683.1, filed on Aug. 30, 2013, both of which are hereby incorporated by reference in their entireties.

### TECHNICAL FIELD

The present invention relates to the field of electronic devices, and in particular, to a method for implementing an electronic magnifier and a user equipment (UE).

### BACKGROUND

With the development of electronic technologies, more content may be displayed on a screen of an electronic terminal. However, because a screen size of an electronic device such as a handheld terminal is limited, when browsing information such as a picture, a table, or text, a user generally cannot clearly view information content due to an excessively small size of the information content.

To clearly view information displayed on a screen, the prior art provides some solution manners, for example, viewing information in a manner of zooming content on an entire displayed page or magnifying a partial area of the displayed page using an electronic magnifier.

Further, a manner of implementing an electronic magnifier is as follows: The electronic magnifier is activated by pressing and holding or double-clicking an instruction on a screen; after the electronic magnifier is activated, the electronic magnifier is kept in an activated state only when an instruction of pressing and holding the electronic magnifier is continuously received; and the electronic magnifier is moved by following movement of a contact for continuously pressing and holding the electronic magnifier. In this way, a magnified area of the electronic magnifier may be moved to any position of displayed content on a display screen, so as to implement magnification of displayed content in different positions.

In a process of implementing the electronic magnifier, the inventor finds that the prior art has at least the following problems: Because the electronic magnifier needs to be continuously pressed and held to implement movement of a position of the magnifier, a hand of a user is greatly constrained, and an operation of pressing and holding causes the displayed content to be shielded, which leads to a complex user operation and inconvenient content viewing.

### SUMMARY

Embodiments of the present invention provide a method for implementing an electronic magnifier and a UE, which may facilitate a user operation and content viewing.

To achieve the foregoing objective, the following technical solutions are adopted in the embodiments of the present invention:

According to a first aspect of the present invention, a method for implementing an electronic magnifier is provided, including when an electronic magnifier of a user equipment UE is activated, determining information about a tilt angle variation of the UE's display screen using a gravity sensor of the UE; and moving a magnified area of the electronic magnifier according to the information about the tilt angle variation, where the magnified area of the electronic magnifier is a part of a display area of the display screen, so that displayed content entering the magnified area is magnified and displayed.

With reference to the first aspect of the present invention, in a first possible implementation manner, the information about the tilt angle variation of the display screen includes a variation vector of the tilt angle of the display screen; and the moving a magnified area of the electronic magnifier according to the information about the tilt angle variation of the display screen includes determining a vector component of the variation vector of the tilt angle on a plane of the display screen according to the variation vector of the tilt angle of the display screen; and moving a position of the magnified area of the electronic magnifier toward a direction of the vector component.

With reference to the first aspect of the present invention, in a second possible implementation manner, the information about the tilt angle variation of the display screen includes a variation vector of the tilt angle of the display screen; and the moving a magnified area of the electronic magnifier according to the information about the tilt angle variation includes determining a vector component of the variation vector of the tilt angle on a plane of the display screen according to the variation vector of the tilt angle of the display screen; and keeping a position of the magnified area of the electronic magnifier relative to an entire display area of the display screen unchanged, and moving displayed content of the display screen toward a direction opposite to the vector component, so that the displayed content that is moved is magnified when passing through the magnified area of the electronic magnifier.

With reference to the first aspect of the present invention or any one of the foregoing implementation manners of the first aspect, in a third possible implementation manner, the determining information about a tilt angle variation of a display screen using a gravity sensor includes acquiring a tilt angle of the display screen at an initial moment as a horizontal reference angle using the gravity sensor; and acquiring a tilt angle of the display screen in real time using the gravity sensor, and comparing the tilt angle of the display screen acquired in real time with the horizontal reference angle, so as to determine the variation vector of the tilt angle of the display screen.

With reference to the first possible implementation manner of the first aspect of the present invention, in a fourth possible implementation manner, the information about the tilt angle variation of the display screen further includes variation amplitude of the tilt angle of the display screen; and the method further includes determining a moving speed of the magnified area according to the variation amplitude of the tilt angle of the display screen; and the moving a magnified area of the electronic magnifier according to the information about the tilt angle variation includes moving the magnified area of the electronic magnifier according to the determined moving speed and the variation vector of the tilt angle.

With reference to the second possible implementation manner of the first aspect of the present invention, in a fifth possible implementation manner, the information about the tilt angle variation of the display screen further includes variation amplitude of the tilt angle of the display screen; and the method further includes determining a moving speed of the magnified area according to the variation amplitude of the tilt angle of the display screen; and the moving a magnified area of the electronic magnifier according to the information about the tilt angle variation includes keeping the position of the magnified area of the electronic magnifier relative to the entire display area of the display screen unchanged, and moving, according to the determined moving speed, the displayed content of the display screen toward the direction opposite to the vector component, so that the displayed content that is moved is magnified when passing through the magnified area of the electronic magnifier.

With reference to the first aspect of the present invention or any one of the foregoing possible implementation manners of the first aspect, in a sixth possible implementation manner, the displayed content of the display screen includes a picture, text, and/or a table; and a shape of the magnified area of the electronic magnifier includes a circle, a rectangle, a rhombus, or a user-defined shape.

With reference to the sixth possible implementation manner of the first aspect of the present invention, in a seventh possible implementation manner, when the displayed content is a table, the shape of the magnified area of the electronic magnifier is a rectangle.

According to a second aspect of the present invention, a UE is provided, including a determining unit configured to, after an electronic magnifier of the UE is activated, determine information about a tilt angle variation of the UE's display screen using a gravity sensor of the UE; a moving unit configured to move a magnified area of the electronic magnifier according to the information about the tilt angle variation, where the information about the variation is determined by the determining unit, and the magnified area of the electronic magnifier is a part of a display area of the display screen; an interface drawing unit configured to draw displayed content outside the magnified area of the magnifier, so as to display the displayed content on the display screen; and a magnifier drawing unit configured to, when displayed content enters the magnified area, magnify and display content within the magnified area.

With reference to the second aspect of the present invention, in a first possible implementation manner, the information about the tilt angle variation of the display screen includes a variation vector of the tilt angle of the display screen; and the moving unit is configured to determine a vector component of the variation vector of the tilt angle on a plane of the display screen according to the variation vector of the tilt angle of the display screen, and move a position of the magnified area of the electronic magnifier toward a direction of the determined vector component.

With reference to the second aspect of the present invention, in a second possible implementation manner, the information about the tilt angle variation of the display screen includes a variation vector of the tilt angle of the display screen; and the moving unit is configured to determine a vector component of the variation vector of the tilt angle on a plane of the display screen according to the variation vector of the tilt angle of the display screen, keep a position of the magnified area of the electronic magnifier relative to an entire display area of the display screen unchanged, and move displayed content of the display screen toward a direction opposite to the determined vector component, so that the displayed content that is moved is magnified when passing through the magnified area of the electronic magnifier.

With reference to the second aspect of the present invention or any one of the foregoing implementation manners of the second aspect, in a third possible implementation manner, the determining unit includes a reference subunit configured to acquire a tilt angle of the display screen at an initial moment as a horizontal reference angle using the gravity sensor; and a determining unit configured to acquire a tilt angle of the display screen in real time using the gravity sensor, and compare the tilt angle of the display screen acquired in real time with the horizontal reference angle, so as to determine the variation vector of the tilt angle of the display screen.

With reference to the first possible implementation manner of the second aspect of the present invention, in a fourth possible implementation manner, the information about the tilt angle variation of the display screen further includes variation amplitude of the tilt angle of the display screen; the determining unit is configured to determine a moving speed of the magnified area according to the variation amplitude of the tilt angle of the display screen; and the moving unit is configured to move the magnified area of the electronic magnifier according to the moving speed determined by the determining unit and a variation vector of the tilt angle, where the variation vector of the tilt angle is determined by the determining unit.

With reference to the second possible implementation manner of the second aspect of the present invention, in a fifth possible implementation manner, the information about the tilt angle variation of the display screen further includes variation amplitude of the tilt angle of the display screen; the determining unit is further configured to determine a moving speed of the magnified area according to the variation amplitude of the tilt angle of the display screen; and the moving unit is configured to keep the position of the magnified area of the electronic magnifier relative to the entire display area of the display screen unchanged, and move, according to the moving speed determined by the determining unit, the displayed content of the display screen toward the direction opposite to the vector component, so that the displayed content that is moved is magnified when passing through the magnified area of the electronic magnifier.

With reference to the second aspect of the present invention or any one of the foregoing possible implementation manners of the second aspect, in a sixth possible implementation manner, the displayed content of the display screen includes a picture, text, and/or a table; and a shape of the magnified area of the electronic magnifier includes a circle, a rectangle, a rhombus, or a user-defined shape.

With reference to the sixth possible implementation manner of the second aspect of the present invention, in a seventh possible implementation manner, when the displayed content is a table, the shape of the magnified area of the electronic magnifier is a rectangle.

According to a third aspect of the present invention, a UE is provided, including a processor configured to trigger a gravity sensor of the UE after an electronic magnifier of the UE is activated; the gravity sensor configured to determine, under triggering of the processor, information about a tilt angle variation of the UE's display screen, where the processor is further configured to move a magnified area of the electronic magnifier according to the information about the tilt angle variation, where the information about the variation is determined by the gravity sensor; and a display screen configured to present displayed content of the UE and the electronic magnifier, where the magnified area of the electronic magnifier is a part of a display area of the display screen, and displayed content entering the magnified area is magnified and displayed.

With reference to the third aspect of the present invention, in a first possible implementation manner, the information about the tilt angle variation of the display screen further includes a variation vector of the tilt angle of the display screen; the processor is further configured to determine a vector component of the variation vector of the tilt angle on a plane of the display screen according to the variation vector of the tilt angle of the display screen, where the variation vector is determined by the gravity sensor; and move a position of magnified area of the electronic magnifier toward a direction of the vector component.

With reference to the third aspect of the present invention, in a second possible implementation manner, the information about the tilt angle variation of the display screen further includes a variation vector of the tilt angle of the display screen; the processor is configured to determine a vector component of the variation vector of the tilt angle on a plane of the display screen according to the variation vector of the tilt angle of the display screen, where the variation vector is determined by the gravity sensor; and keep a position of the magnified area of the electronic magnifier relative to an entire display area of the display screen unchanged, and move displayed content of the display screen toward a direction opposite to the vector component, so that the displayed content that is moved is magnified when passing through the magnified area of the electronic magnifier.

With reference to the third aspect of the present invention or any one of the foregoing implementation manners of the third aspect, in a third possible implementation manner, the gravity sensor is configured to under triggering of the processor, acquire a tilt angle of the display screen at an initial moment as a horizontal reference angle; and acquire a tilt angle of the display screen in real time, and compare the tilt angle of the display screen acquired in real time with the horizontal reference angle, so as to determine the variation vector of the tilt angle of the display screen.

With reference to the first possible implementation manner of the third aspect of the present invention, in a fourth possible implementation manner, the information about the tilt angle variation of the display screen further includes variation amplitude of the tilt angle of the display screen; the gravity sensor is further configured to determine the variation amplitude of the tilt angle of the display screen, and determine, according to the variation amplitude of the tilt angle of the display screen, a moving speed of the magnified area; and the processor is configured to move the magnified area of the electronic magnifier according to the moving speed determined by the gravity sensor and the variation vector of the tilt angle, where the direction is determined by the gravity sensor.

With reference to the second possible implementation manner of the third aspect of the present invention, in a fifth possible implementation manner, the information about the tilt angle variation of the display screen further includes variation amplitude of the tilt angle of the display screen; the gravity sensor is further configured to determine a moving speed of the magnified area according to the variation amplitude of the tilt angle of the display screen; and the processor is configured to keep the position of the magnified area of the electronic magnifier relative to the entire display area of the display screen unchanged, and move, according to the moving speed determined by the gravity sensor, the displayed content of the display screen toward the direction opposite to the vector component, so that the displayed content that is moved is magnified when passing through the magnified area of the electronic magnifier.

With reference to the third aspect of the present invention or any one of the foregoing possible implementation manners of the third aspect, in a sixth possible implementation manner, the displayed content of the display screen includes a picture, text, and/or a table; and a shape of the magnified area of the electronic magnifier includes a circle, a rectangle, a rhombus, or a user-defined shape.

With reference to the sixth possible implementation manner of the third aspect of the present invention, in a seventh possible implementation manner, when the displayed content is a table, the shape of the magnified area of the electronic magnifier is a rectangle.

According to the method for implementing an electronic magnifier and the UE that are provided in the embodiments of the present invention, after an electronic magnifier is activated, a position of a magnified area of the electronic magnifier is moved toward a corresponding position according to information about a tilt angle variation of a display screen, where the information about the variation is determined by a gravity sensor. Compared with a technology in the prior art that a user needs to continuously press and hold and move a position of an electronic magnifier, a continuous pressing and holding operation is not required after the magnifier is activated. Therefore, a hand operation of the user is simplified, shielding of displayed content by a pressing operation is avoided, and a purpose of facilitating a user operation and content viewing is achieved.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a flowchart of a method for implementing an electronic magnifier according to an embodiment of the present invention;

FIG. 2 is a flowchart of a method for implementing an electronic magnifier according to another embodiment of the present invention;

FIG. 3 is a schematic diagram of a horizontal reference angle according to another embodiment of the present invention;

FIG. 4 is a schematic diagram of a tilt angle of a display screen according to another embodiment of the present invention;

FIG. 5 is a schematic diagram of an actual scenario of movement of a magnifier according to the present invention;

FIG. 6 is a schematic diagram of another actual scenario of movement of a magnifier according to the present invention;

FIG. 7 is a schematic diagram of a screen rotation scenario according to another embodiment of the present invention;

FIG. 8 is a schematic diagram of composition of a UE according to another embodiment of the present invention;

FIG. 9 is a schematic diagram of composition of a UE according to another embodiment of the present invention; and

FIG. 10 is a schematic diagram of composition of a UE according to another embodiment of the present invention.

### DESCRIPTION OF EMBODIMENTS

The following clearly describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

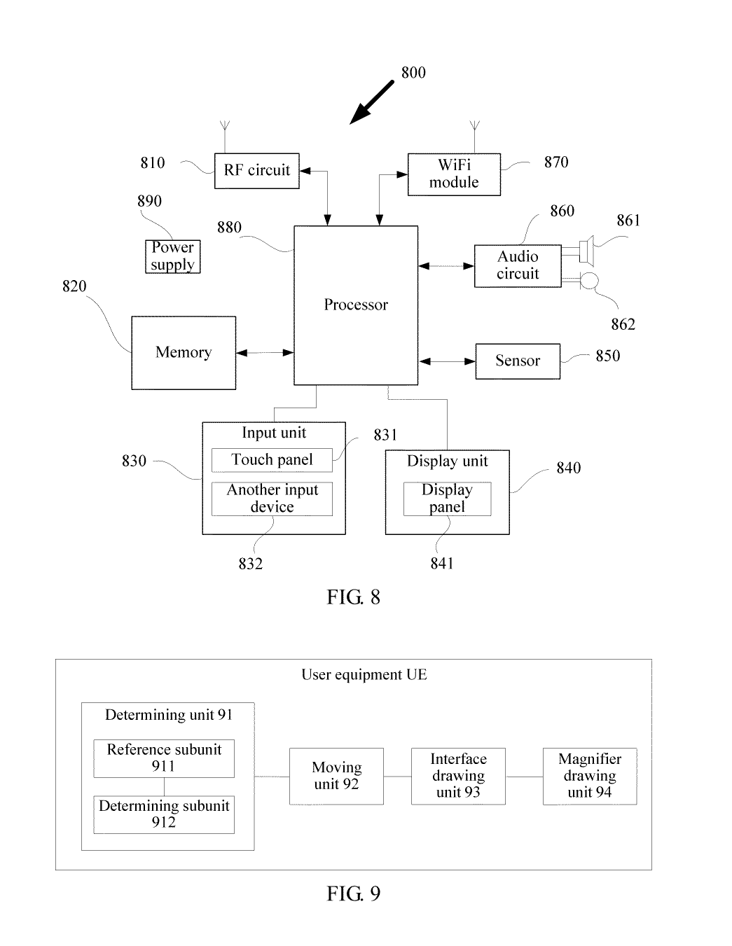

First, a mobile phone shown in FIG. 8 is used as an example to describe a UE applied in the present invention. The mobile phone includes parts such as a radio frequency (RF) circuit 810, a memory 820, an input unit 830, a wireless fidelity (WiFi) module 870, a display unit 840, a sensor 850, an audio circuit 860, a processor 880, and a power supply 890.

A person skilled in the art may understand that a mobile phone structure shown in FIG. 8 does not constitute a limit to the mobile phone, where more or less parts than those shown in the figure may be included, or some parts are combined, or different parts are arranged.

The RF circuit 810 may be configured to receive or send a signal during an information transceiving or conversation process, particularly, after downlink information of a base station is received, the RF circuit 810 sends the downlink information to the processor 880 for processing; and send uplink data to the base station. Generally, the RF circuit includes but is not limited to an antenna, at least one amplifier, a transceiver, a coupler, a low noise amplifier (LNA), a duplexer, and the like. In addition, the RF circuit 810 may further communicate with a network and another device by means of wireless communication. The wireless communication may use any communications standard or protocol, which includes but is not limited to the Global System for Mobile Communications (GSM), a general packet radio service (GPRS), Code Division Multiple Access (CDMA), Wideband Code Division Multiple Access (WCDMA), Long Term Evolution (LTE), an email, a short message service (SMS), and the like.

The memory 820 may be configured to store a software program and a module. The processor 880 performs various function applications of the mobile phone and data processing by running the software program and the module that are stored in the memory 820. The memory 820 may mainly include a storage program area and a storage data area, where the storage program area may store an operating system, an application program required by at least one function (such as a voice playing function and an image playing function), and the like, and the storage data area may store data (such as audio data and a phone book) created according to usage of the mobile phone, and the like. In addition, the memory 820 may include a high speed random access memory, and may further include a nonvolatile memory, for example, at least one magnetic disk storage component, a flash memory component, or another nonvolatile solid-state storage component.

The input unit 830 may be configured to receive an input digit or character information and generate a key signal related to a user setting and function control of a mobile phone 800. Further, the input unit 830 may include a touch panel 831 and another input device 832. The touch panel 831, which is also referred to as a touchscreen, may collect a touch operation of a user on or near the touch panel 831, for example, an operation of the user on the touch panel 831 or near the touch panel 831 using a finger, a stylus, or any suitable object or accessory, and drive a corresponding connection apparatus according to a preset program. Optionally, the touch panel 831 may include two parts: a touch detection apparatus and a touch controller. The touch detection apparatus detects a touch position of the user, detects a signal generated by means of a touch operation, and transmits the signal to the touch controller. The touch controller receives touch information from the touch detection apparatus, converts the touch information to a contact coordinate, sends the touch spot coordinate to the processor 880, and receives and executes a command sent by the processor 880. In addition, the touch panel 831 may be implemented using multiple types, such as a resistive type, a capacitive type, an infrared ray type, and a surface acoustic wave type. In addition to the touch panel 831, the input unit 831 may further include the other input device 832. Further, the other input device 832 may include but is not limited to one or more of a physical keyboard, a function key (such as a volume control key and a switch key), a trackball, a mouse, a joystick, and the like.

The display unit 840 may be configured to display information input by the user or information provided for the user and various menus of the mobile phone. The display unit 840 may include a display panel 841. Optionally, the display panel 841 may be configured in a form, such as a liquid crystal display (LCD) and an organic light-emitting diode (OLED). Further, the touch panel 831 may cover the display panel 841. When detecting a touch operation on or near the touch panel 831, the touch panel 831 transmits touch information to the processor 880 to determine a type of a touch event, and then the processor 880 provides corresponding visual output on the display panel 841 according to the type of the touch event. In FIG. 8, the touch panel 831 and the display panel 841 are used as two independent parts to implement an input and output function of the mobile phone. However, in some embodiments, the touch panel 831 and the display panel 841 may be integrated to implement the input and output function of the mobile phone.

The mobile phone 800 may further include at least one sensor 850, such as a light sensor, a motion sensor, and other sensors. Further, the light sensor may include an ambient light sensor and a proximity sensor, where the ambient light sensor may adjust luminance of the display panel 841 according to light and shade of ambient light, and the proximity sensor may turn off the display panel 841 and/or backlight when the mobile phone is moved near an ear. A gravity sensor used in the present invention is a type of a motion sensor, and the gravity sensor uses an elastic sensitive element to make a cantilevered shifter and uses an energy storage spring made of the elastic sensitive element to drive an electronic contact, so as to implement conversion from a gravity change to an electrical signal change. Composition and a form of the gravity sensor are not limited in the embodiments of the present invention. A sensor of another form that can detect tilt information of a display screen may be used in the embodiments of the present invention, and falls within the protection scope of the present invention. As a type of a motion sensor, an accelerometer sensor may detect a value of acceleration on each direction (generally, three axes); when at rest, may detect a value and a direction of gravity, and may be used in an application (such as screen switching between portrait and landscape, a related game, and magnetometer posture calibration) of recognizing a posture of a mobile phone, a function related to vibration recognition (such as a pedometer and knocking), and the like. For other sensors that may be configured in the mobile phone, such as a gyroscope, a barometer, a hygrometer, a thermometer, and an infrared sensor, no further details are provided herein.

The audio circuit 860, a loudspeaker 861, and a microphone 862 may provide an audio interface between the user and the mobile phone. The audio circuit 860 may transmit the received electrical signal after conversion of audio data to the loudspeaker 861, and the loudspeaker 861 converts the electrical signal to a voice signal for output; in another aspect, the microphone 862 converts a collected signal voice to an electrical signal, the audio circuit 860 receives the electrical signal, converts the electrical signal to audio data, and outputs the audio data to the processor 880 for processing, the processor 880 processes the audio data and sends the processed audio data to another mobile phone through the RF circuit 810, or the processor 880 outputs the audio data to the memory 820 for further processing.

WiFi belongs to a short-distance wireless transmission technology. The mobile phone may help, using a WiFi module 870, the user to send and receive an email, browse a web page, access streaming media, and the like. The WiFi module 870 provides wireless broadband Internet access for the user. FIG. 8 shows the WiFi module 870, however, it may be understood that the WiFi module 870 does not belong to mandatory composition of the mobile phone 800, and may completely be omitted according to requirements within a range without changing the essence of the invention.

The processor 880, which is a control center of the mobile phone, connects to each part of the entire mobile phone using various types of interfaces and lines, and performs various functions of the mobile phone and data processing by running or executing the software program and/or module that are stored in the memory 820 and invoking data stored in the memory 820, so as to perform overall monitoring on the mobile phone. Optionally, the processor 880 may include one or more processing units. Preferably, the processor 880 may integrate an application processor and a modulation and demodulation processor, where the application processor mainly processes the operating system, a user interface, an application program, and the like, and the modulation and demodulation processor mainly processes wireless communication.

It may be understood that the modulation and demodulation processor may also not be integrated into the processor 880.

The mobile phone 800 further includes the power supply 890 (such as a battery) that supplies power for each part.

Preferably, the power supply may be logically connected to the processor 880 using a power supply management system, so as to implement management of functions, such as charging, discharging, and power consumption management, using the power supply management system. The mobile phone 800 may further include a camera, a Bluetooth module, and the like that are not shown, which is not further described herein. It should be noted that FIG. 8 is merely an example of an electronic terminal. The present invention may be applied to an electronic device, such as a mobile phone, a tablet computer, an iPad, and a personal digital assistant (PDA), which is not limited in the present invention.

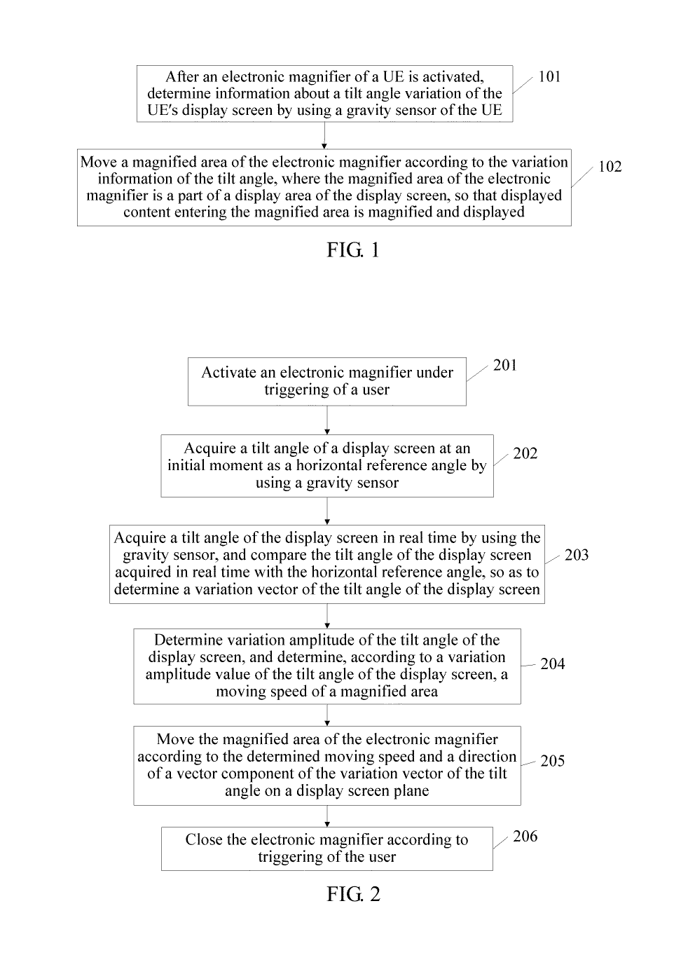

The following describes the present invention with reference to specific embodiments. An embodiment of the present invention provides a method for implementing an electronic magnifier. As shown in FIG. 1, the method includes:

101. After an electronic magnifier of a UE is activated, determine information about a tilt angle variation of the UE's display screen using a gravity sensor of the UE.

The electronic magnifier simulates a real magnifier in a software manner using an electronic control displayed on a display screen, so as to partially magnify and display displayed content on the display screen. That is, a magnified area of the electronic magnifier is a part of a display area of the entire display screen, and the displayed content entering the magnified area is magnified and displayed. An activation manner of the electronic magnifier may be a pressing and holding instruction, a double-clicking instruction, a special activation gesture, or the like, which is not limited in this embodiment of the present invention. The tilt angle of the display screen is relative to a preset horizontal reference angle of the display screen. Therefore, the information about the tilt angle variation of the display screen may be determined according to the tilt angle and the horizontal reference angle. For ease of description, the information about the tilt angle variation may be indicated by a vector. It may be understood that meaning of a variation vector of the tilt angle may include a direction of the vector and a size of the vector. The variation vector of the tilt angle indicates a rotation direction of the display screen, and the size of the variation vector of the tilt angle indicates a rotation amplitude value of the display screen. For example, if a horizontal position that is parallel to a horizontal plane is preset to the horizontal reference angle of the display screen, a variation of the tilt angle is caused when the display screen tilts leftward, rightward, forward, or backward, and the information about the tilt angle variation of the display screen is obtained. Definitely, the tilt angle variation of the display screen is relative to the horizontal reference angle. Using the horizontal position as the horizontal reference angle is only an implementation manner. A vertical position that is perpendicular to the horizontal plane or another angle may also be used as the horizontal reference angle, which is not limited in this embodiment.

102. Move a magnified area of the electronic magnifier according to the information about the tilt angle variation, where the magnified area of the electronic magnifier is a part of a display area of the display screen, so that displayed content entering the magnified area is magnified and displayed.

A method for moving the magnified area of the electronic magnifier according to the information about the tilt angle variation may be as follows: A position of the magnified area of the electronic magnifier is moved toward a direction of a vector component of the variation vector of the tilt angle on a plane of the display screen. The method may also be as follows: A position of the magnified area of the electronic magnifier relative to an entire display area is kept unchanged, and the displayed content of the display screen is moved toward a direction opposite to the vector component of the variation vector of the tilt angle on the display screen plane, where the displayed content that is moved is magnified when passing through the magnified area of the electronic magnifier. Definitely, the method for moving the magnified area of the electronic magnifier according to the information about the tilt angle variation may also be a combination of the foregoing two manners. When the magnified area of the magnifier is located in a middle part of the display screen, the position of the magnified area of the electronic magnifier is moved toward the direction of the vector component of the variation vector of the tilt angle on the plane of the display screen; when the magnified area of the magnifier is located on an edge of the display screen, the position of the magnified area of the electronic magnifier relative to the entire display area is kept unchanged, and the displayed content of the display screen is moved toward the direction opposite to the vector component of the variation vector of the tilt angle on the plane of the display screen.

Further, a moving speed may further be determined according to a variation amplitude value of the tilt angle at the same time when a moving direction of the magnified area is determined. The movement speed increases when the variation amplitude of the tilt angle gets larger; on the contrary, the movement speed decreases when the variation amplitude of the tilt angle gets smaller.

In the method for implementing an electronic magnifier provided in this embodiment of the present invention, after an electronic magnifier is activated, a position of a magnified area of the electronic magnifier is moved toward a corresponding position according to information about a tilt angle variation of a display screen, where the information about the variation is determined by a gravity sensor. Compared with a technology in the prior art that a user needs to continuously press and hold and move a position of an electronic magnifier, a continuous pressing and holding operation is not required after the magnifier is activated. Therefore, a hand operation of the user is simplified, shielding of displayed content by a pressing operation is avoided, and a purpose of facilitating a user operation and content viewing is achieved.

Another embodiment of the present invention provides a method for implementing an electronic magnifier. As shown in FIG. 2, the method includes:

201. Activate an electronic magnifier under triggering of a user.

In this embodiment, a horizontal reference angle preset in a system may be used. A horizontal reference angle of a display screen may be preset before the magnifier is activated, and definitely may also be set after the magnifier is activated.

202. Acquire a tilt angle of a display screen at an initial moment as a horizontal reference angle using a gravity sensor.

Movement of a magnified area of the magnifier is determined according to the tilt angle of the display screen, and the tilt angle is collected by the gravity sensor. Therefore, before the movement of the magnifier is implemented, the horizontal reference angle of the display screen at initial time needs to be predetermined. A configuration parameter of the horizontal reference angle may be system default configuration, and may also be selected according to an actual requirement of the user.

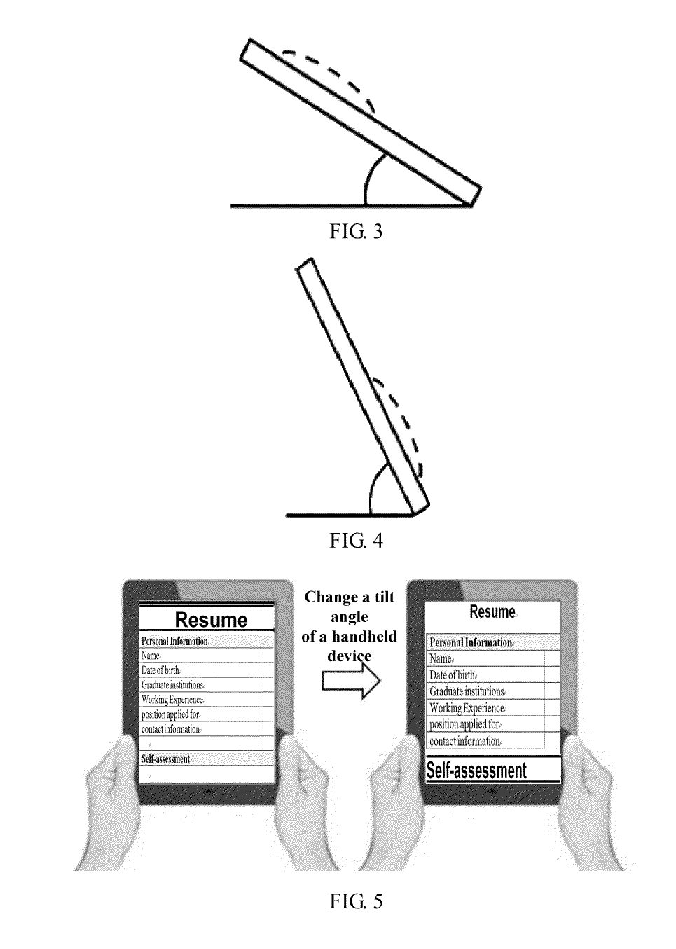

For example, as shown in FIG. 3, at the same time when the electronic magnifier is activated, the gravity sensor acquires a tilt angle of the display screen at current time as the horizontal reference angle. The horizontal reference angle shown in FIG. 3 is forward tilt at 30° (degrees) and leftward-or-rightward tilt at 0°. A position drawn with a dashed line in an upper part of the screen is a position of the magnifier displayed on the display screen, and is drawn schematically for easily determining the position of the magnifier.

203. Acquire a tilt angle of the display screen in real time using the gravity sensor, and compare the tilt angle of the display screen acquired in real time with the horizontal reference angle, so as to determine a variation vector of the tilt angle of the display screen.

The gravity sensor may monitor the tilt angle in real time and may also acquire the tilt angle periodically. Definitely, real-time performance of movement of the magnifier is better when frequency of acquiring the tilt angle is higher. When the user changes the tilt angle of the display screen, the gravity sensor may detect a changed tilt angle, and compare the detected tilt angle with the horizontal reference angle. When the tilt angle increases, the magnifier is moved toward a direction that the angle increases; similarly, when the tilt angle decreases, the magnifier is moved toward a direction that the tilt angle decreases. For this movement manner, reference may be made to a scenario in which a small ball is placed on a tray. For example, if a tilt angle of a device is larger than a horizontal reference angle that is initially set, it is regarded that the user tilts the device downward and a convex mirror is moved downward. On the contrary, if the tilt angle is smaller than the set horizontal reference angle, it is regarded that the user tilts the device upward and the convex mirror is moved upward. As shown in FIG. 4, an angle of the display screen tilting forward increases to 60°, and an angle of tilting leftward or rightward is unchanged. Therefore, the position of the magnifier is moved downward as shown in FIG. 4, and a relative position between a position of the moved magnifier and the initial position of the magnifier is determined according to a relative relationship between a changed tilt angle and a horizontal reference angle. A presentation manner is shown in FIG. 5.

204. Determine variation amplitude of the tilt angle of the display screen, and determine, according to a variation amplitude of the tilt angle of the display screen, a moving speed of the magnified area.

Step 204 is an optional step. To further simulate a physical scenario in which the ball on the tray is moved on the tray by tilting the tray and bring a more real operation feeling, a method in step 205 may be used to adjust the moving speed of the magnifier. The moving speed of the magnifier is higher when a change of the changed tilt angle relative to the initial tilt angle is greater. For example, if tilting forward at 30 degrees is used as the horizontal reference angle, when the tilt angle is 45 degrees, it takes 2 seconds for the magnifier to move from the top of the screen to the bottom of the screen; and when the tilt angle is 60 degrees, it takes only 1 second for the magnifier to move from the top of the screen to the bottom of the screen.

205. Move the magnified area of the electronic magnifier according to the determined moving speed and a direction of a vector component of the variation vector of the tilt angle on a plane of the display screen.

It should be noted that, in this embodiment, a case in which information about a tilt angle variation of the display screen includes the variation vector of the tilt angle of the display screen is used as an example. Further, the information about the tilt angle variation of the display screen may further include the variation amplitude of the tilt angle of the display screen, a variation rate of the tilt angle of the display screen, or the like. Definitely, the information about the tilt angle variation of the display screen may further include information in another form, which is not described as examples one by one in this embodiment.

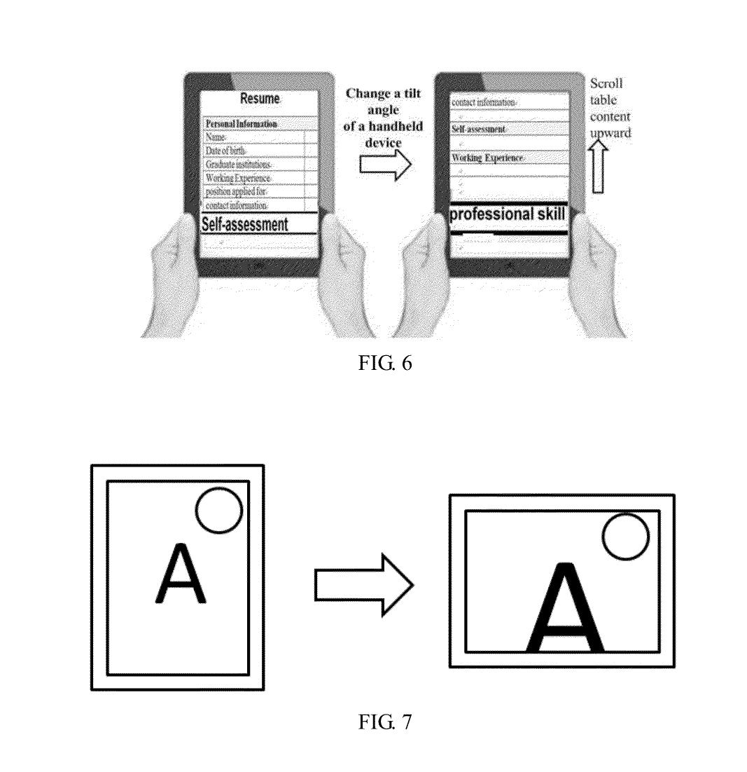

Optionally, in a possible implementation scenario, a method for moving the magnified area of the electronic magnifier according to the information about the tilt angle variation may be as follows: A position of the magnified area of the electronic magnifier is moved toward the direction of the vector component of the variation vector of the tilt angle on the display screen plane. For example, in the scenario shown in FIG. 5, the upper part of the display screen is tilted toward a direction of the user and the position of the magnifier is moved downward. In another possible implementation scenario, the method for moving the magnified area of the electronic magnifier according to the information about the tilt angle variation may be as follows: A position of the magnified area of the electronic magnifier relative to the entire display area is kept unchanged, and displayed content of the display screen is moved toward a direction opposite to the vector component of the variation vector of the tilt angle on the plane of the display screen, where the displayed content that is moved is magnified when passing through the magnified area of the electronic magnifier. For example, as shown in FIG. 6, the upper part of the display screen is tilted toward the direction of the user, the position of the magnifier is unchanged, and displayed content is moved upward. In another possible implementation scenario, the method for moving the magnified area of the electronic magnifier according to the information about the tilt angle variation may also be a combination of the foregoing two manners. That is, when the magnifier does not reach an edge of the display screen, the position of the magnified area of the electronic magnifier is moved toward the direction of the vector component of the variation vector of the tilt angle on the plane of the display screen; when the magnifier is on the edge of the display screen, the position of the magnified area of the electronic magnifier relative to the entire display area is kept unchanged, and the displayed content of the display screen is moved toward the direction opposite to the vector component of the vector of the tilt angle on the display screen plane.

It may be understood that, to adapt to a visual feeling of the user, when the gravity sensor detects that the display screen is rotated, with reference to an adjustment of a display interface after an existing screen is rotated, for example, an adjustment from portrait display to landscape display, the magnifier may follow an adjusted display interface to keep a position of the magnifier relative to the display interface unchanged. For example, as shown in FIG. 7, the position of the magnifier is in an upper right corner of the display screen. When the user rotates the device to change the device from a vertical direction to a lateral direction, the magnifier does not rotate to an upper left corner along with the device but is still presented in the upper right corner by following interface information on which the magnifier acts. Definitely, with reference to the interface adjustment, a relative position of the magnifier on lateral and vertical axes on the screen also needs to be adjusted accordingly.

206. Close the electronic magnifier according to triggering of the user.

A manner of closing the magnifier may be pressing and holding, double-clicking, shaking, or another special gesture, which is not limited in this embodiment.

Optionally, the displayed content of the display screen includes a picture, text, and/or a table; and a shape of the magnified area of the electronic magnifier includes a circle, a rectangle, a rhombus, or a user-defined shape. Particularly, when the displayed content is a table, the shape of the magnified area of the electronic magnifier is a rectangle.

In the method for implementing an electronic magnifier provided in this embodiment of the present invention, after an electronic magnifier is activated, a position of a magnified area of the electronic magnifier is moved toward a corresponding position according to information about a tilt angle variation of a display screen, where the information about the variation is determined by a gravity sensor. Compared with a technology in the prior art that a user needs to continuously press and hold and move a position of an electronic magnifier, a continuous pressing and holding operation is not required after the magnifier is activated. Therefore, a hand operation of the user is simplified, shielding of displayed content by a pressing operation is avoided, and a purpose of facilitating a user operation and content viewing is achieved.

Another embodiment of the present invention further provides a UE, as shown in FIG. 9, including a determining unit 91 configured to determine information about a tilt angle variation of the UE's display screen using a gravity sensor of the UE after an electronic magnifier of the UE is activated; a moving unit 92 configured to move a magnified area of the electronic magnifier according to the information about the tilt angle variation, where the information about the variation is determined by the determining unit 91, and the magnified area of the electronic magnifier is a part of a display area of the display screen; an interface drawing unit 93 configured to draw displayed content outside the magnified area of the magnifier, so as to display the displayed content on the display screen; and a magnifier drawing unit 94 configured to, when displayed content enters the magnified area, magnify and display content within the magnified area.

Further, optionally, in a first application scenario, the information about the tilt angle variation of the display screen includes a variation vector of the tilt angle of the display screen; and the moving unit 92 is configured to determine a vector component of the variation vector of the tilt angle on a plane of the display screen according to the variation vector of the tilt angle of the display screen, and move a position of the magnified area of the electronic magnifier toward a direction of the determined vector component.

Further, optionally, in a second application scenario, the information about the tilt angle variation of the display screen includes a variation vector of the tilt angle of the display screen; and the moving unit 92 is configured to determine a vector component of the variation vector of the tilt angle on a plane of the display screen according to the variation vector of the tilt angle of the display screen, keep a position of the magnified area of the electronic magnifier relative to an entire display area of the display screen unchanged, and move displayed content of the display screen toward a direction opposite to the determined vector component, so that the displayed content that is moved is magnified when passing through the magnified area of the electronic magnifier.

Further, the determining unit 91 includes a reference subunit 911 configured to acquire a tilt angle of the display screen at an initial moment as a horizontal reference angle using the gravity sensor; and a determining subunit 912 configured to acquire a tilt angle of the display screen in real time using the gravity sensor, and compare the tilt angle of the display screen acquired in real time with the horizontal reference angle acquired by the reference subunit 911, so as to determine the variation vector of the tilt angle of the display screen.

Further, optionally, in the first application scenario, the information about the tilt angle variation of the display screen further includes variation amplitude of the tilt angle of the display screen; the determining unit 91 is further configured to determine the variation amplitude of the tilt angle of the display screen using the gravity sensor, and determine, according to the variation amplitude of the tilt angle of the display screen, a moving speed of the magnified area.

The moving unit 92 is configured to move the magnified area of the electronic magnifier according to the moving speed determined by the determining unit 91 and the variation vector of the tilt angle, where the direction is determined by the determining unit 91.

Further, optionally, in the second application scenario, the information about the tilt angle variation of the display screen further includes variation amplitude of the tilt angle of the display screen; the determining unit 91 is further configured to determine the moving speed of the magnified area according to the variation amplitude of the tilt angle of the display screen; and the moving unit 92 is configured to keep the position of the magnified area of the electronic magnifier relative to the entire display area of the display screen unchanged, and move, according to the moving speed determined by the determining unit 91, the displayed content of the display screen toward the direction opposite to the vector component, so that the displayed content that is moved is magnified when passing through the magnified area of the electronic magnifier.

Further, the displayed content of the display screen includes a picture, text, and/or a table; and a shape of the magnified area of the electronic magnifier includes a circle, a rectangle, a rhombus, or a user-defined shape.

Further, when the displayed content is a table, the shape of the magnified area of the electronic magnifier is a rectangle.

It should be noted that, an implementation process of modules in the UE shown in FIG. 9, information exchange between the modules, and other content are based on a same inventive concept as method embodiments of the present invention. Therefore, reference may be made to the method embodiments, and no further details are provided herein.

In the UE provided in this embodiment of the present invention, after an electronic magnifier is activated, a position of a magnified area of the electronic magnifier is moved toward a corresponding position according to information about a tilt angle variation of a display screen, where the information about the variation is determined by a gravity sensor. Compared with a technology in the prior art that a user needs to continuously press and hold and move a position of an electronic magnifier, a continuous pressing and holding operation is not required after the magnifier is activated. Therefore, a hand operation of the user is simplified, shielding of displayed content by a pressing operation is avoided, and a purpose of facilitating a user operation and content viewing is achieved.

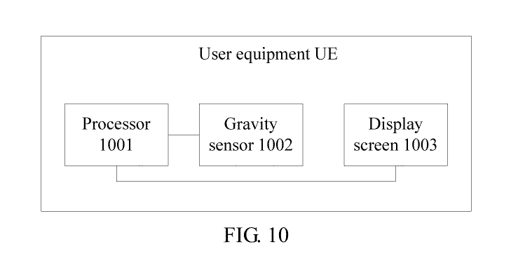

Another embodiment of the present invention further provides a UE, as shown in FIG. 10, including a processor 1001 configured to trigger a gravity sensor of the UE after an electronic magnifier of the UE is activated; a gravity sensor 1002 configured to determine information about a tilt angle variation of the UE's display screen under triggering of the processor 1001, where the processor 1001 is further configured to move a magnified area of the electronic magnifier according to the information about the tilt angle variation, where the information about the variation is determined by the gravity sensor 1002; and a display screen 1003 configured to present displayed content of the UE and the electronic magnifier, where the magnified area of the electronic magnifier is a part of a display area of the display screen, and displayed content entering the magnified area is magnified and displayed.

The processor 1001 may use a general central processing unit (CPU), a microprocessor, an application specific integrated circuit (ASIC), or one or more integrated circuits, and is configured to execute a related program, so as to implement technical solutions provided in embodiments of the present invention.

Further, optionally, in a first application scenario, the information about the tilt angle variation of the display screen includes a variation vector of the tilt angle of the display screen; and the processor 1001 is configured to determine a vector component of the variation vector of the tilt angle on a plane of the display screen according to the variation vector of the tilt angle of the display screen 1003, where the variation vector is determined by the gravity sensor 1002; and move a position of the magnified area of the electronic magnifier toward a direction of the vector component.

Further, optionally, in a second application scenario, the information about the tilt angle variation of the display screen includes a variation vector of the tilt angle of the display screen; and the processor 1001 is configured to determine a vector component of the variation vector of the tilt angle on a plane of the display screen according to the variation vector of the tilt angle of the display screen 1003, where the variation vector is determined by the gravity sensor 1002; keep a position of the magnified area of the electronic magnifier relative to an entire display area of the display screen 1003 unchanged; and move displayed content of the display screen 1003 toward a direction opposite to the vector component, where the displayed content that is moved is magnified when passing through the magnified area of the electronic magnifier.

Further, the gravity sensor 1002 is configured to under triggering of the processor 1001, acquire a tilt angle of the display screen 1003 at an initial moment as a horizontal reference angle, acquire a tilt angle of the display screen 1003 in real time, and compare the tilt angle of the display screen acquired in real time with the horizontal reference angle, so as to determine the variation vector of the tilt angle of the display screen 1003.

Further, optionally, in the first application scenario, the information about the tilt angle variation of the display screen may further include variation amplitude of the tilt angle of the display screen; the gravity sensor 1002 is further configured to determine the variation amplitude of the tilt angle of the display screen 1003, and determine, according to the variation amplitude of the tilt angle of the display screen 1003, a moving speed of the magnified area; and the processor 1001 is configured to move the magnified area of the electronic magnifier according to the moving speed determined by the gravity sensor 1002 and the variation vector of the tilt angle, where the direction is determined by the gravity sensor 1002.

Further, optionally, in the second application scenario, the information about the tilt angle variation of the display screen further includes variation amplitude of the tilt angle of the display screen; the gravity sensor 1002 is further configured to determine a moving speed of the magnified area according to the variation amplitude of the tilt angle of the display screen 1003; and the processor 1001 is configured to keep the position of the magnified area of the electronic magnifier relative to the entire display area of the display screen unchanged, and move, according to the moving speed determined by the gravity sensor 1002, the displayed content of the display screen 1003 toward the direction opposite to the vector component, so that the displayed content that is moved is magnified when passing through the magnified area of the electronic magnifier.

Further, the displayed content of the display screen 1003 includes a picture, text, and/or a table; and a shape of the magnified area of the electronic magnifier includes a circle, a rectangle, a rhombus, or a user-defined shape.

Further, when the displayed content is a table, the shape of the magnified area of the electronic magnifier is a rectangle.

It should be noted that, an implementation process of modules in the UE shown in FIG. 10, information exchange between the modules, and other content are based on a same inventive concept as method embodiments of the present invention. Therefore, reference may be made to the method embodiments, and no further details are provided herein.

In the UE provided in this embodiment of the present invention, after an electronic magnifier is activated, a position of a magnified area of the electronic magnifier is moved toward a corresponding position according to information about a tilt angle variation of a display screen, where the information about the variation is determined by a gravity sensor. Compared with a technology in the prior art that a user needs to continuously press and hold and move a position of an electronic magnifier, a continuous pressing and holding operation is not required after the magnifier is activated. Therefore, a hand operation of the user is simplified, shielding of displayed content by a pressing operation is avoided, and a purpose of facilitating a user operation and content viewing is achieved.

According to the foregoing descriptions of the implementation manners, a person skilled in the art may clearly understand that the present invention may be implemented by software and necessary universal hardware and definitely may also be implemented by hardware, but in many cases, the former is a preferred implementation manner. Based on such an understanding, the technical solutions of the present invention essentially or the part contributing to the prior art may be implemented in a form of a software product. The computer software product is stored in a readable storage medium, such as a floppy disk, a hard disk or an optical disc of a computer, and includes several instructions for instructing a computer device (which may be a personal computer, a server, a network device, or the like) to execute the methods described in the embodiments of the present invention.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for implementing an electronic magnifier, comprising:
determining information about a tilt angle variation of a display screen of a user equipment (UE) using a gravity sensor of the UE when an electronic magnifier of the UE is activated; and
moving a magnified area of the electronic magnifier according to the information about the tilt angle variation, wherein the magnified area of the electronic magnifier is a part of a display area of the display screen, so that displayed content entering the magnified area is magnified and displayed.

2. The method for implementing an electronic magnifier according to claim 1, wherein the information about the tilt angle variation of the display screen comprises a variation vector of the tilt angle of the display screen, and wherein moving a magnified area of the electronic magnifier according to the information about the tilt angle variation comprises:
determining a vector component of the variation vector on a plane of the display screen; and
moving the magnified area of the electronic magnifier toward a direction of the vector component.

3. The method for implementing an electronic magnifier according to claim 2, wherein the information about the tilt angle variation of the display screen further comprises variation amplitude of the tilt angle of the display screen, wherein the method further comprises determining a moving speed of the magnified area according to the variation amplitude of the tilt angle of the display screen, and wherein the moving a magnified area of the electronic magnifier according to the information about the tilt angle variation comprises moving the magnified area of the electronic magnifier according to the determined moving speed and the variation vector of the tilt angle.

4. The method for implementing an electronic magnifier according to claim 1, wherein the information about the tilt angle variation of the display screen comprises a variation vector of the tilt angle of the display screen, and wherein moving a magnified area of the electronic magnifier according to the information about the tilt angle variation comprises:
determining a vector component of the variation vector on a plane of the display screen;
keeping a position of the magnified area of the electronic magnifier unchanged; and
moving displayed content of the display screen toward a direction opposite to the vector component, so that the displayed content that is moved is magnified when passing through the magnified area of the electronic magnifier.

5. The method for implementing an electronic magnifier according to claim 4, wherein the information about the tilt angle variation of the display screen further comprises variation amplitude of the tilt angle of the display screen, wherein the method further comprises determining a moving speed of the magnified area according to the variation amplitude of the tilt angle of the display screen, and wherein the moving a magnified area of the electronic magnifier according to the information about the tilt angle variation comprises:
keeping the position of the magnified area of the electronic magnifier unchanged; and
moving, according to the determined moving speed, the displayed content of the display screen toward the direction opposite to the vector component.

6. The method for implementing an electronic magnifier according to claim 1, wherein determining information about the tilt angle variation of the display screen of the UE using the gravity sensor comprises:
acquiring a tilt angle of the display screen at an initial moment as a horizontal reference angle using the gravity sensor;
acquiring a tilt angle of the display screen in real time using the gravity sensor; and
comparing the tilt angle of the display screen acquired in real time with the horizontal reference angle, so as to determine the variation vector of the tilt angle of the display screen.

7. The method for implementing an electronic magnifier according to claim 1, wherein displayed content of the display screen comprises a picture, text, and/or a table, and wherein a shape of the magnified area of the electronic magnifier comprises a circle, a rectangle, a rhombus, or a user-defined shape.

8. The method for implementing an electronic magnifier according to claim 7, wherein when the displayed content is a table, and wherein the shape of the magnified area of the electronic magnifier is a rectangle.

9. A user equipment (UE) comprising:
a processor configured to trigger a gravity sensor of the UE after an electronic magnifier of the UE is activated;
the gravity sensor configured to determine information about a tilt angle variation of the UE's display screen under triggering of the processor, wherein the processor is further configured to move a magnified area of the electronic magnifier according to the information about the tilt angle variation; and
a display screen configured to present displayed content of the UE and the electronic magnifier, wherein the magnified area of the electronic magnifier is a part of a display area of the display screen, and wherein displayed content entering the magnified area is magnified and displayed.

10. The UE according to claim 9, wherein the information about the tilt angle variation of the UE's display screen comprises a variation vector of the tilt angle of the UE's display screen; and the processor is configured to:
determine a vector component of the variation vector on a plane of the display screen, wherein the variation vector is determined by the gravity sensor; and
move the magnified area of the electronic magnifier toward a direction of the vector component.

11. The UE according to claim 10, wherein the information about the tilt angle variation of the UE's display screen further comprises variation amplitude of the tilt angle of the UE's display screen, wherein the gravity sensor is further configured to determine a moving speed of the magnified area according to the variation amplitude of the tilt angle of the display screen, wherein the processor is configured to move the magnified area of the electronic magnifier according to the moving speed determined by the gravity sensor and the variation vector of the tilt angle, and wherein the variation vector of the tilt angle is determined by the gravity sensor.

12. The UE according to claim 9, wherein the information about the tilt angle variation of the display screen comprises a variation vector of the tilt angle of the display screen, and wherein the processor is configured to:
determine a vector component of the variation vector on a plane of the display screen, wherein the variation vector is determined by the gravity sensor;
keep a position of the magnified area of the electronic magnifier unchanged; and
move displayed content of the display screen toward a direction opposite to the vector component, so that the displayed content that is moved is magnified when passing through the magnified area of the electronic magnifier.

13. The UE according to claim 12, wherein the information about the tilt angle variation of the UE's display screen further comprises variation amplitude of the tilt angle of the UE's display screen, wherein the gravity sensor is further configured to determine a moving speed of the magnified area according to the variation amplitude of the tilt angle of the UE's display screen, and wherein the processor is configured to:
keep the position of the magnified area of the electronic magnifier unchanged; and
move, according to the moving speed determined by the gravity sensor, the displayed content of the display screen toward the direction opposite to the vector component, so that the displayed content that is moved is magnified when passing through the magnified area of the electronic magnifier.

14. The UE according to claim 9, wherein the gravity sensor is configured to:
acquire a tilt angle of the display screen at an initial moment as a horizontal reference angle;
acquire a tilt angle of the display screen in real time; and
compare the tilt angle of the display screen acquired in real time with the horizontal reference angle, so as to determine the variation vector of the tilt angle of the display screen.

15. The UE according to claim 9, wherein displayed content of the display screen comprises a picture, text, and/or a table, and wherein a shape of the magnified area of the electronic magnifier comprises a circle, a rectangle, a rhombus, or a user-defined shape.

16. The UE according to claim 15, wherein when the displayed content is a table, the shape of the magnified area of the electronic magnifier is a rectangle.
